(19) United States
(12) Patent Application Publication
(10) Pub. No.: US 2005/0163814 A1
(43) Pub. Date: Jul. 28, 2005

(54) Granulated phosphoroamido(di) thioates

(76) Inventor: Jesse Gaytan, Valdosta, GA (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/508,407

(22) PCT Filed: Mar. 26, 2003
(86) PCT No.: PCT/IB03/04944

Related U.S. Application Data
(60) Provisional application No. 60/367,503, filed on Mar. 27, 2002.

(51) Int. Cl. A01N 57/00; A01N 25/00

(52) U.S. Cl. 424/405; 514/114

(57) ABSTRACT

The present invention relates to a process for extruding heat sensitive phosphoroamido(di)thioates in the form of finely divided solids, powers or crystals into granules. The invention is also directed to a process of producing granules of phosphoroamido(di)thioates having enhanced structural integrity. Insecticidally active phosphoroamido(di)thioate solid granules are compacted more easily and with higher structural integrity by milling, preferably by jet milling, the solids to a particle size distribution wherein the solids exhibit (a) an average crystal length of less than 150 μm and an average crystal width of less than 40 μm and/or (b) a particle size distribution having at least 67 wt % of said solids within a size of 4.6-88 μm.

The present invention relates to a process for extruding heat sensitive phosphoroamido(di)thioates in the form of finely divided solids, powders or crystals into granules. The invention is also directed to a process of producing granules of phosphoroamido-(di)thioates having enhanced structural integrity.

Powdered materials can be compacted and formed into shapes of extended length by extrusion. Generally speaking, a progressively threaded extrusion screw is rotated at a preselected rate to convey a feed material into an enclosed section to an extrusion die opening. Frictional forces through the die opening resist the forward conveying action of the progressive screw and compact the feed material as it passes through the die opening. The more resistant the powder to compaction, the higher are the applied die backpressure and frictional heating. It is not uncommon for some extruders operating at normal, commercial extrusion rates to expose the extruded material to temperature increases of 25° to 100° C.

Inorganic materials, such as ceramics, can benefit from the heat and friction of the passage through the die opening. Such ceramic extrudates are effectively dewatered and compacted sufficiently to form a wet “green” extrudate of sufficient integrity to with-stand handling and more complete drying. Organic materials can be severely degraded by the high temperatures encountered when passing the extrusion mixture through an extrusion die. Such factors have limited manufacture of organic materials so that they are either not extruded or require such slow extrusion screw speeds that the manufacturing process is limited in its production rate.

N-hydrocarboyl phosphoroamidothioates and phosphoroamidodithioates (referred to herein as “phosphoroamido(di)thioates”) are classes of particularly heat sensitive compounds that are used as systemic insecticides in a variety of environments. One of the most commercially important compounds within this class is acephate. Acephate and related compounds are described in U.S. Pat. No. 3,716,600, U.S. Pat. No. 3,845,172 and U.S. Pat. No. 3,914,417.

Orthene® is a commercial form of acephate that is produced as a technical grade chemical of about 97 to 99.5% purity. It is available as a wettable powder from Valent Corporation.

It would be desirable to have an extrusion process for heat sensitive active ingredients like the phosphoroamido(di)thioates that does not expose the extruded active ingredient to deleterious temperature increases at the extrusion die and which will form adequately dense extrudates at a commercially acceptable rate.

Chevron and Valent have received a number of patents for processes to manufacture pelleted or granular acephate. U.S. Pat. No. 5,075,058 describes phosphoroamido(di)thioate pellets with a second active ingredient (insecticide, fungicide, herbicide, or fertilizer), a surfactant that is used to encapsulate the phosphoroamido(di)thioate active, an anhydrous magnesium sulfate as a dehydrating agent to absorb moisture and prevent hydrolysis of the phosphoroamido(di)thioate, a deodorant, and an anti-foaming agent. The mix is extruded through a die at 30 to 40° C. and dried.

U.S. Pat. No. 5,100,667 describes a solvent-free method for making phosphoroamido(di)thioate pellets that relies on a dry mix with a solid surfactant to provide structural integrity. The example shows the use of ammonium sulfate in addition to the phosphoroamido(di)thioate and surfactant.

U.S. Pat. No. 5,464,623 teaches two processes to pelletize phosphoroamido(di)thioates. One uses a solvent for the technical grade compound to make a pourable or extrudable mixture. The list of preferred solvents include hexane, carbon tetrachloride, toluene, ispropanol, ethanol, chloroform, methanol, and methylene chloride. The other process avoids use of a solvent and melts the technical grade compound at about 90° C. for subsequent molding or spraying into droplets.

U.S. Pat. No. 5,298,501 describes the use of 83-98 wt % ammonium sulfate for providing integrity to granules containing 2-17 wt % of a phosphoroamido(di)thioate.

U.S. Pat. No. 5,352,674 discloses a formulation containing a phosphoroamido(di)thicate, an optional second active ingredient (e.g., a fungicide), at least 75 wt % of ammonium sulfate, 0.2-5 wt % of a surfactant, 0.05-2 wt % of a deodorant, and 1-5 wt % of granular processing aids that are selected from a lubricant (Mg stearate, Ca stearate, Zn stearate, and silicon emulsions) in an amount within the range of 0.5-5 wt %, a binder (corn starch, polymers, and natural gums), and 0.5-5 wt % of a flowability aid (colloidal silica, and micronized clay). All examples use significant quantities of ammonium sulfate to form a structural granule. Indeed, Example 3 of the '674 patent illustrates the adverse storage effects of formulations that do not contain ammonium sulfate.

U.S. Pat. No. 5,369,100 is directed to a formulation that does not use a binder. Instead, the formulation relies on compaction of a mix containing the technical form of the active and ammonium sulfate. Lubricants (Mg stearate) and flow aids (silica particles) are also added to the formulation as shown in the examples.

U.S. Pat. No. 6,013,272 teaches the manufacture of water-free phosphoroamido(di)thioate granules without added solvent by heating the extrusion die to a temperature that is sufficient to soften the active solids while controlling the rate at which water is added. Final products are disclosed as having a moisture level of less than 0.5 wt %. It is disclosed in column 5 that small amounts of a vinylpyrrolidone-vinyl acetate copolymer does not adversely affect the process and that the process does not require the use of surfactants or binding agents.

Importantly, each of these patents uses the powdered technical grade of acephate as supplied by the producer. The prior art then looks to formulations and extrusion processing techniques to compact the acephate. Each process has significant limitations.

It was an objective of this invention to provide an extrusion process that does not subject the extruded material to high temperature rises at the die even when operated at normal, commercially economic speeds.

It was another objective of this invention to provide an extrusion process using a highly effective material that acts as both a lubricant in the extruder and a binder in the final product. Such a process can be run at ambient temperatures without cooling of the extrusion die or a controlled introduction of coolants or other liquids into the extruded formulation.

In accordance with these and other objectives of the invention that will become apparent from the description herein, the invention relates to a composition and its manufacturing process that includes the step of extruding at ambient temperatures a mixture comprising milled phosphoroamido(di)thioate solids wherein the solids have been milled to a sufficiently narrow particle size distribution and/or sufficiently small crystal size to be granulated by extrusion through a conventional extruder. In a preferred embodiment, the extrusion is operated without the addition of water, its subsequent removal, or the detrimental effects of hydrolysis upon storage due to residual moisture.

The process of the invention consistently provides phosphoroamido(di)thioate extrudates of good density and structural integrity that allows formation of a commercially acceptable granular insecticide product. The process mills the phosphoroamido(di)thioate to reduce the particle size to a sufficiently small particle size to enable the resulting particles to be compacted readily into granules having an enhanced structural integrity compared to particles that have not been milled.

FIG. 1 is a graph of the particle size distribution of technical grade acephate solids obtained from a manufacturer.

FIG. 2 is a graph of the particle size distribution of the technical grade acephate solids that have been milled in accordance with this invention.

The phosphoroamido(di)thioates that can be used in the invention include insecticidally active compounds having the general formula I 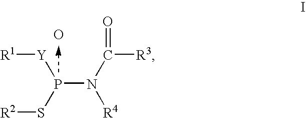
wherein
R¹ and R² individually are an alkyl, alkenyl or alkynyl group containing up to 6 carbon atoms,
R³ is hydrogen, an alkyl group containing 1 to 18 carbon atoms, a cycloalkyl group containing 3 to 8 carbon atoms, an alkenyl group containing 2 to 18 carbon atoms or an alkynyl group containing 3 to 18 carbon atoms,
R⁴ is hydrogen or an alkyl group containing 1 to 6 carbon atoms, and
Y is oxygen or sulfur.

Acephate is a particularly preferred phosphoroamido(di)thioate insecticide for use in the present invention. It is commercially available in a technical grade solid of at least 97 wt % purity and is used in extruded granules of the present invention in an amount of at least 92 wt %, preferably at least 94 wt %, and most preferably in an amount of at least 95 wt % based on total weight of the dried granule. Unless otherwise indicated herein, all percentages are by weight relative to the total weight of the product.

Acephate is commercially available as an elongated, crystalline solid that has already been processed to break up lumps and aggregates of materials but not to reduce the crystal size of the active ingredient (“delumped”; see U.S. Pat. No. 6,013,272 at column 6). The delumped, crystalline solid of acephate technical grade is commercially available and generally has average dimensions within the range of 250-500 μm in length, 40-100 μm in width, and an aspect ratio (length:width) of about 1-10. The mean particle size is about 28-31 μm with a median of about 11-12 μm at a standard deviation within the range of 40-50.

According to the present invention, crystalline solids of delumped, technical grade acephate are comminuted, milled, ground, or processed by another size reduction process to reduce the average size of the crystalline solids, render the crystalline solids brighter (i.e., more reflective), and concentrate the particles to a size that allows the solids to be extruded into durable granules. It has been determined that better granules are formed by concentrating the particle sizes to at least a majority of particles having a size within the range of 3.9-37 μm (i.e., retained on a sieve opening of 3.9 μm but passing through a sieve opening greater than about 37 μm, such as an opening of 44 μm).

Preferably, the desired crystal size and distribution is attained by a milling process that can be adjusted to or which naturally tends to narrow the particle size distribution of the processed solids. The technical grade of phosphoroamido(di)thioate solids is most preferably milled in a jet mill, low energy hammer, centrifugal mill, or pin mill.

It has been found that milling the technical grade phosphoroamido(di)thioate solids, and particularly acephate solids, enhances the processing and compacting characteristics of the solids and helps to produce an extruded granule of better integrity and density relative to granules of unmilled phosphoroamido(di)thioate solids. The milled product when processed in the extruder produces an extrudate that has an enhanced structural integrity compared to the technical grade product that has not been milled. It has been proposed that the smaller crystals having an irregular shape are able to interlock together when compacted to enhance the structural integrity of the extruded product. In addition, the increased surface area of the milled product enables the binding agent to provide a stronger particle-to-particle bond.

In a preferred embodiment, the crystals of the phosphoroamido(di)thioate solids are milled to an average crystal length of less than 150 μm, an average width of less than 40 μm, and an aspect ratio (UD) within the range of about 1-7. Preferably, the milled phosphoroamido(di)thioate crystals exhibit a mean size within the range of 10-29 μm, more preferably within the range of 12-25 μm, and most preferably within the range of 15-23 μm with a standard deviation of less than 40, more preferably less than 35, and most preferably less than 30.

Even more preferably, the phosphoroamido(di)thioate solids are milled to produce a product exhibiting a particle size distribution whereby at least 67 wt % (preferably at least 68 wt %, and most preferably at least 70 wt %) of the solids have a particle size within the range of 4.6-88 μm (i.e., retained on a sieve with openings between 4.6 and 88 μm). It is also preferred that at least 52 wt % (even more preferably 55 wt %, and especially at least 60 wt %) of the milled phosphoroamido(di)thioate solids have a particle size within the range of 4.6-37 μm and less than 14 wt % (even more preferably less than 13 wt %, and especially less than 11 wt %) have a size within the range of 44-88 μm.

The milled phosphoroamido(di)thioate solids of the invention exhibit a higher bulk density than the unmilled, delumped solids obtained from the manufacturer. The extruded phosphoroamido(di)thioate solids should then form extrudates having a higher bulk density than the uncompacted milled solids. Preferred bulk densities for the extruded granules are at least 450 g/l, more preferably within a range of 475-650 g/l, particularly within the range of 500-600 g/l, and especially within the range from about 525-575 g/l. The granules have a resistance to attrition of at least 60%, preferably at least about 62%. Typically, the extruded granules have a resistance to attrition of about 63% to about 64% as determined by ASTM method E-728-91.

The extruded phosphoroamido(di)thioate compositions of the invention can also include one or more anticaking agents or other processing aids. An anticaking agent can be added, if desired, in an amount sufficient to prevent or reduce clumping and caking of the extrudates and dried granules. Generally no more than about 1.5 wt % is needed. Silica powder in an amount within the range of 0.5-1.25 wt % is particularly useful.

Processing aids is a term that includes any insecticidally inert additive that is used to facilitate formation of granules of compacted particulates of the phosphoroamido(di)thioate solids. Suitable processing aids include water, surfactants, ammonium sulfate, polymeric aids (e.g., a vinyl copolymer such as vinylpyrrolidone-vinyl acetate copolymer, a polyalkylene oxide, etc.), and a solvent for a polymeric aid (e.g., dimethylsulfoxide for a polyalkylene oxide lubricant/binder). The preferred additives include a silica-based anticaking agent, a polymeric binding aid, and an amount of a solvent (aqueous or nonaqueous) for the polymeric aid that is sufficient to dissolve the polymer and lubricate the mixture as it passes through an extruder for compaction and granule formation.

Even more preferably, the extrusion is performed with a dissolvable polymeric binder (e.g., a polyalkylene oxide like polyethylene oxide) and a small amount of solvent for the polymeric binder (water, dimethylsulfoxide, water-alcohol azeotrope, and mixtures thereof so as to render the polymeric component at least partially dissolved and lubricious in the extrusion mixture. Preferably, the polymeric binder and the solvent are included in an amount effective to provide a lubricating effect on the particulates and milled particles to reduce the back pressure and prevent overheating of the particles in the extruder. With sufficient lubricity, the extrusion can be performed in the absence of controlled cooling or heating of the extrusion die and without the introduction of coolant liquid into the formulation. In the most preferred embodiment of the present invention, only so much solvent is added as is needed to render the polymeric component lubricious for the extrusion process and effective as a binder in the final granular product.

In the manufacturing process, an extrudable mixture containing phosphoroamido(di)thioate solids that have been milled to size according to the invention are passed through an extrusion die having a diameter within the range from about 1-10 mm. The extruder can be a standard single or twin screw extruder as known in the art that is suitable for extruding particulate and producing extruded granules. The mixture is then extruded into granules. While the most preferred embodiment of the present invention reduces the frictional heat through the die and extrusion can be performed at any desired temperature, the extrusion process is preferably performed at or controlled to perform at ambient temperatures (e.g., 15 to 22° C.) or a similar temperature that is sufficiently low that it does not degrade the insecticidal activity of the phosphoroamido(di)thioate solids.

The extrudate exiting from the extrusion die can be sliced or cut to length before entering a drier to remove any excess solvent. Suitable driers include convention ovens, fluidized beds, and the like. Use of a fluidized bed operating at a temperature less than the melting point of the technical grade of active ingredient is particularly preferred. For example, acephate has a melting point within the range of 63 to 67° C., so operation of the drier at a temperature of less than 60° C. is preferred when granulating acephate.

If water is used in the process or the phosphoroamido(di)thioate solids have absorbed moisture from the ambient atmosphere, the extrudates should be dried to a residual moisture content of less than 1 wt %, preferably to a residual moisture content within the range of 0.01-0.5 wt %, and even more preferably within the range from about 0.01-0.3 wt %, based on total weight of the dried extrudate. Usually, no more than about 2-5 minutes is required for adequate drying of a well extruded extrudate.

### EXAMPLES

### Examples 1-4

A sample of technical grade acephate crystals was obtained (Examples 1 and 3) and compared. The crystal shape and size distribution were found to be essentially the same for each of the commercial sources. Half of each sample was analyzed for brightness and particle size distribution.

TABLE 1
GE Brightness

| Sample | Brightness |
|---|---|
| Ex. 1 - Source A (unmilled) | 87.2 |
| Ex. 2 - Source A (milled) | 88.4 |
| Ex. 3 - Source B (unmilled) | 90.2 |
| Ex. 4 - Source B (milled) | 93.7 |

Examination of the brightness results shows that the milling process of the present invention changed a number of properties. Milling caused a measurable increase in the brightness of the bulk powder sample as measured by reflected light. Such an increase is visually apparent as a noticeably brighter powder when compared side-by-side under the GE Brightness test.

Visual inspection of the milled and unmilled samples also revealed that the milling process of the invention changed the average crystal length and width of the acephate technical. The unmilled acephate from example 3 was a commercially available technical grade having elongated cylindrical shaped crystals with an average crystal length of 250-500 μm and an average width of 40-100 μm. In contrast, the acephate powder of example 4 was made of substantially cylindrical shaped crystals with an average crystal length of less than about 150 μm and an average width of less than 40 μm.

The other half of the Source B sample was analyzed for particle size distribution as received and with the milling according to the invention. The particle size distribution is reported in detail in Table 2 and summarized in Table 3. Additional details about the crystalline acephate solids are presented in Table 4. FIG. 1 (unmilled) and FIG. 2 (milled) are graphs of the particle size distributions from the milling process. All values are in terms of weight percent of total sample that could pass through the designated sieve opening.

TABLE 2
Particle Size Distribution

| Size (μm) | Unmilled | Milled |
|---|---|---|
| <1.9 | 9.6625 | 7.9543 |
| 1.9 | 3.6123 | 3.7746 |
| 2.3 | 1.6125 | 1.8957 |
| 2.8 | 3.3402 | 3.9085 |
| 3.3 | 5.0469 | 4.3981 |
| 3.9 | 4.5533 | 5.0539 |
| 4.6 | 2.9044 | 4.0079 |
| 5.5 | 3.2481 | 4.6002 |
| 6.5 | 5.7966 | 5.3931 |
| 7.8 | 4.6403 | 5.6669 |
| 9.2 | 4.2474 | 6.1254 |
| 11 | 4.6232 | 6.0030 |
| 13 | 4.6531 | 5.4418 |
| 16 | 3.3203 | 4.6925 |
| 19 | 3.2150 | 4.8575 |
| 22 | 3.1651 | 4.9085 |
| 26 | 3.7619 | 4.4529 |
| 31 | 3.7231 | 3.4498 |
| 37 | 3.2123 | 2.4873 |
| 44 | 3.0323 | 2.0818 |
| 53 | 3.3767 | 2.3280 |
| 63 | 3.2501 | 2.2067 |
| 75 | 2.8069 | 1.5439 |
| 88 | 2.4665 | 1.2313 |
| 105 | 2.0819 | 0.8371 |
| 125 | 1.5293 | 0.4144 |
| 149 | 1.3606 | 0.1331 |
| 177 | 0.7768 | 0.1199 |
| 210 | 0.4565 | 0.0486 |
| 250 | 0.2321 | 0.132 |
| 298 | 0.1849 | 0.0000 |
| >298 | 0.1068 | 0.0000 |

TABLE 3
Summary Particle Size Distribution

| | |
|---|---|
| Unmilled (wt %) | Milled (wt %) |

| Sieve Size (μm) | Range | Cumul. | Range | Cumul. |
|---|---|---|---|---|
| <1.9 | 13.27 | 13.27 | 11.73 | 11.73 |
| 2.3-3.9 | 14.55 | 27.83 | 15.26 | 26.99 |
| 4.6-16 | 33.43 | 61.26 | 41.93 | 68.92 |
| 19-37 | 17.08 | 78.34 | 20.16 | 89.07 |
| 44-88 | 14.93 | 93.27 | 9.39 | 98.46 |
| 105-149 | 4.97 | 98.24 | 1.38 | 99.85 |
| >177 | 1.76 | ˜100* | 0.30 | ˜100* |
| <3.9 | 27.83 | | 26.99 | |
| 4.6-88 | 65.44 | | 71.47 | |
| >105 | 6.73 | | 1.54 | |
| <3.9 | 27.83 | | 26.99 | |
| 4.6-37 | 50.51 | | 62.09 | |
| 44-88 | 14.93 | | 9.39 | |
| >105 | 6.73 | | 1.68 | |

*subject to rounding

TABLE 4

| | Unmilled | Milled |
|---|---|---|
| mean (μm) | 30.4 | 19.1 |
| median (μm) | 11.7 | 10.3 |
| standard deviation | 45.5 | 24.6 |
| Crystal dimensions | (100-280) × (40-50) | (40-90) × (20-25) |
| (length × width) (μm) | | |
| Aspect ratio | 2.5-5.6 | 2-3.6 |
| extrusion | inconsistent compaction | consistent with high |
| | | structural integrity |

As seen from Tables 2-4, milling of the technical grade powder from the manufacturer reduced the percentage of particles of 88 μm or more. The milling process also made the particle distribution more uniform (37% reduction in the mean particle size, 46% drop in standard deviation despite only a 12% change in median particle size) and a significantly higher concentration of particles within the range of 4.6-88 μm.

The effects of these particle size distribution changes produced a technical grade acephate powder that exhibited an ability to be consistently compacted via extrusion into granules of good structural integrity.

### Examples 5-6

This example demonstrates the enhanced structural integrity of the extruded granules obtained from milled acephate compared to unmilled technical grade acephate. A stainless steel Laboratory Dome Granulator (Model No. DG-L1) was run at 70 rpm with a fed rate of 800 g/min. The extrusion blade was a two flight type in a single component with a feed screw. The Dome Die was 1 mm×1.2 mm.

A mixture of the milled technical grade of acephate powder from example 4 was added to an extruder comprising 0.5 wt % Poly-Ox™ Resin N-10 (polyethylene oxide) as a binder and drag reducing agent, 1.0 wt % of Hi-Sil™ HOA (silica) as a flow aid, 3.0 wt % DMSO (dimethyl sulfoxide) and the balance acephate. The mixture was extruded through a 1 mm die and cut into granules. The DMSO flashes off during extrusion to produce granules having the following composition:

| | Wt % |
|---|---|
| Example 5 (invention) | |
| Milled Acephate technical (ex. 4) | 98.5 |
| Polyethylene oxide | 0.5 |
| Silica | 1.0 |
| Example 6 (comparative) | |
| Unmilled Acephate technical (ex. 3) | 98.5 |
| Polyethylene oxide | 0.5 |
| Silica | 1.0 |

Each sample was analyzed with the results as follows:

| | Ex. 5 | Ex. 6 |
|---|---|---|
| pH (1.0%) | 4.6 @ 21° C. | 4.6 @ 21° C. |
| Dissolution Rate: (slight agitation) | 20-40 sec. | 20-40 sec. |
| Moisture Content: Acephate extruded | 0.17 | 0.36 |
| granule | | |
| Bulk Density (free fall): | | |
| Acephate technical | 392 g/l | — |
| Acephate tech + 1% Hi-Sil ™ HOA | 470.5 g/l | — |
| Acephate extruded granule | 544.6 g/l | 440.0 g/l |
| Angle of repose: | | |
| Acephate tech | 60° | |
| Acephate + 1% Hi-Sil ™ HOA | 51° | |
| Acephate extruded granule | 26° | 26° |
| Extruded Granule Size: | | |
| Diameter | 1.0 mm | 1.5 mm |
| Length | 1-4 mm | 1-6 mm |
| Resistance to Attrition:* | 63.3% | 59.5% |

*ASTM test method E-728-91 was used to determine resistance to attrition.

Comparison of examples 5 and 6 show an increase in the structural integrity of the extruded granules for milled acephate powder according to the invention as determined by the bulk density and resistance to attrition. One reason for this enhanced integrity may be the notable increase in density of the extruded granule according to the invention (544.6 g/l) compared to the granule (440 g/l) formed by the manufacturer's material that was not milled according to the invention.

Indeed, milled and granulated phosphoroamido(di)thioate solids according to the invention preferably exhibit a bulk density within the range of 475-650 g/l, more preferably a bulk density within the range of 500-600 g/l, and especially preferred is a bulk density within the range of 525-575 g/l.

1. A process for making granules of an insecticidally active phosphoroamido(di)thioate solid by compacting a phosphoroamido(di)thioate solid that has been milled (a) to an average crystal length of less than 150 μm and an average crystal width of less than 40 μm, or (b) to a particle size distribution having at least 67 wt % of said solids within a size of 4.6-88 μm.

2. The process according to claim 1, wherein said phosphoroamido(di)thioate solids has been jet milled.

3. The process according to claim 1, wherein said phosphoroamido(di)thioate solid exhibits a mean size within the range of 10-29 μm.

4. The process according to claim 1, wherein said phosphoroamido(di)thioate solid exhibits a mean size within the range of 12-25 μm.

5. The process according to claim 1, wherein said phosphoroamido(di)thioate solid exhibits a mean size within the range of 15-23 μm.

6. The process according to claim 1, wherein said phosphoroamido(di)thioate solid exhibits a standard deviation of less than 40.

7. The process according to claim 1, wherein said phosphoroamido(di)thioate solid exhibits a standard deviation of less than 35.

8. The process according to claim 1, wherein said phosphoroamido(di)thioate solid exhibits a standard deviation of less than 30.

9. The process according to claim 1, wherein said phosphoroamido(di)thioate solid has been milled to a particle size distribution whereby at least 68 wt % of said solid has a particle size of 4.6-88 μm.

10. The process according to claim 1, wherein said phosphoroamido(di)thioate solid has been milled to a particle size distribution whereby at least 70 wt % of said solid has a particle size of 4.6-88 μm.

11. The process according to claim 1 wherein said phosphoroamido(di)thioate solid has been milled to a particle size distribution whereby at least 52 wt % of said solid has a size within the range of 4.6-37 μm and less than 14 wt % of said solid has a size within the range of 44-88 μm.

12. The process according to claim 10 wherein said phosphoroamido(di)thioate solid has been milled to a particle size distribution whereby at least 55 wt % of said solid has a size within the range of 4.6-37 μm and less than 13 wt % has a size within the range of 44-88 μm.

13. The process according to claim 10 wherein said phosphoroamido(di)thioate solid has been milled to a particle size distribution whereby at least 60 wt % of said solid has a size within the range of 4.6-37 μm and less than 11 wt % has a size within the range of 44-88 μm.

14. The process of claim 1 wherein the compacting step is performed by passing the milled solid, a binding agent, and a nonaqueous solvent for said binder through an extruder.

15. The process according to claim 1, wherein said granules have a bulk density of at least 450 g/l.

16. The process according to claim 1, wherein said granules have a bulk density of about 450 g/l to about 650 g/l.

17. The process according to claim 1, wherein said granules comprise about 0.5 wt % of polymeric binder and about 1.0 wt % of a particulate flow aid and the balance acephate.

18. The process according to claim 1, wherein said granules comprise about 0.5 wt % of a polyethylene oxide binder, about 0.5 wt % silica and the balance acephate.

19. Compacted granules of a milled crystalline phosphoroamido(di)thioate solid wherein said solid has been jet milled (a) to an average crystal length of less than 150 μm and an average crystal width of less than 40 μm, or (b) to a particle size distribution having at least 67 wt % of said solid with a size of 4.6-88 μm.

20. The compacted granules of a milled phosphoroamido(di)thioate solid according to claim 19, wherein said solid further exhibits a mean size within the range of 10-29 μm.

21. The compacted granules of a milled phosphoroamido(di)thioate solid according to claim 19, wherein said solid further exhibits a mean size within the range of 12-25 μm.

22. The compacted granules of a milled phosphoroamido(di)thioate solid according to claim 19, wherein said solid further exhibits a mean size within the range of 15-23 μm.

23. The compacted granules of a milled phosphoroamido(di)thioate solid according to claim 19, wherein said solid has a particle size with a standard deviation of less than 40 μm.

24. The compacted granules of a milled phosphoroamido(di)thioate solid according to claim 19, wherein said solid has a particle size with a standard deviation of less than 35 μm.

25. The compacted granules of a milled phosphoroamido(di)thioate solid according to claim 19, wherein said solid has a particle size with a standard deviation of less than 30 μm.

26. The compacted granules of a milled phosphoroamido(di)thioate solid according to claim 19, wherein said solid has been jet milled to a particle size distribution whereby said phosphoroamido(di)thioate solid has been milled to a particle size distribution whereby at least 68 wt % of said solid has a particle size of 4.6-88 μm.

27. The granules according to claim 19, wherein said phosphoroamido(di)thioate solid has been milled to a particle size distribution whereby at least 70 wt % of said solid has a particle size of 4.6-88 μm.

28. The granules according to claim 19 wherein said phosphoroamido(di)thioate solid has been milled to a particle size distribution whereby at least 52 wt % of said solid has a size within the range of 4.6-37 μm and less than 14 wt % of said solid has a size within the range of 44-88 μm.

29. The process according to claim 19 wherein said phosphoroamido(di)thioate solid has been milled to a particle size distribution whereby at least 55 wt % of said solid has a size within the range of 4.6-37 μm and less than 13 wt % has a size within the range of 44-88 μm.

30. The process according to claim 19 wherein said phosphoroamido(di)thioate solid has been milled to a particle size distribution whereby at least 60 wt % of said solid has a size within the range of 4.6-37 μm and less than 11 wt % has a size within the range of 44-88 μm.

31. The compacted granules of a milled phosphoroamido(di)thioate solid according to claim 19, wherein said granules have a bulk density of at least 450 g/l.

32. The compacted granules of a milled phosphoroamido(di)thioate solid according to claim 19, wherein said granules have a bulk density of about 450 g/l to about 650 g/l.

33. The compacted granules of a milled phosphoroamido(di)thioate solid according to claim 19, wherein said granules comprise a binder, a particulate flow aid, and acephate.

34. The compacted granules of a milled phosphoroamido(di)thioate solid according to claim 33, wherein said binder comprises a polyethylene oxide polymer.
